(19) United States
(12) Patent Application Publication
(10) Pub. No.: US 2014/0198812 A1
(43) Pub. Date: Jul. 17, 2014

(54) Communications Network Transport Node, Optical Add-Drop Multiplexer and Method of Routing Communications Traffic

(71) Applicants: Bengt-Erik Olsson, Hovas (SE); Fabio Cavaliere, Vecchiano (IT); Patrizia Testa, Solna (SE)

(72) Inventors: Bengt-Erik Olsson, Hovas (SE); Fabio Cavaliere, Vecchiano (IT); Patrizia Testa, Solna (SE)

(73) Assignee: Telefonaktiebolaget L M Ericsson (publ), Stockholm (SE)

(21) Appl. No.: 14/123,753

(22) PCT Filed: Jun. 3, 2011
(86) PCT No.: PCT/EP2011/059201

§ 371 Date: Feb. 13, 2014

(51) Int. Cl. H04J 14/02

(52) U.S. Cl. CPC H04J 14/0215
USPC 370/542; 398/83

(57) ABSTRACT

A communications network transport node comprising an optical add-drop multiplexer (OADM), comprising optical signal processing apparatus, electrical signal routing apparatus, and a packet switch. Each optical signal processing apparatus comprises an optical input, an optical output, optical-to-electrical (O-E) signal conversion apparatus arranged to receive input optical channel signals and to convert each into an input radio frequency (RF) modulated electrical channel signal, and electrical to optical (E-O) signal conversion apparatus arranged to receive output RF modulated electrical channel signals and to convert each into an output optical channel signal. The electrical signal routing apparatus determines which input RF modulated electrical channel signals are to be dropped, and routes these to the electrical drop outputs, and which are to be transmitted, and routes these to a selected E-O apparatus. The routing apparatus receives further electrical channel signals and routes these to a selected E-O apparatus.

### TECHNICAL FIELD

The invention relates to a communications network transport node, an optical add-drop multiplexer and method of routing communications traffic carrying signals in a communications network transport node.

### BACKGROUND

Communications transport networks are facing significant challenges in order to scale in capacity and meet more stringent requirements on network bandwidth and delay imposed by the emerging internet protocol (IP) based services. An important step towards a more dynamic and flexible converged network solution, that better adapts to the nature of IP traffic, has been represented by the implementation of the packet layer on an optical layer enhanced with optical switching capabilities provided by all optical reconfigurable optical add drop multiplexers (ROADMs). A ROADM is an all-optical subsystem, integrated within a wavelength division multiplexed (WDM) communications network, which allows remote configuration of wavelengths at each network node. In ROADM based network architectures the interconnection between routers is provided by end to end optical channels (light-paths) and transit traffic can be switched at the light-path level without opto-electronic conversion.

The use of ROADMs based on wavelength selective switching (WSS) technology has improved optical network flexibility, as reported by P. Roorda et al “Evolution to Colorless and Directionless ROADM Architectures”, National Fiber Optic Engineers Conference (NFOEC), San Diego, Feb. 24, 2008. ROADMs face two key limitations: firstly, all add/drop transceivers are coupled to fixed add/drop wavelengths; and secondly, each multiplexer/demultiplexer is connected to a specific outbound direction. This means that the assignment of both the wavelength and the direction of add/drop channels requires manual intervention. Using WSS technology, ROADM flexibility can be extended to provide colourless (tunable wavelength) and directionless (selectable output direction) add/drop switching. However this results in high equipment cost since it requires a large number of WSSs that increases with node degree and add/drop capacity. Another issue with all-optical switching solutions is switching between optical wavelengths is not practicable since the technology for all-optical wavelength conversion still is very immature.

### SUMMARY

It is an object to provide an improved communications network transport node. It is a further object to provide an improved optical add-drop multiplexer. It is a further object to provide an improved method of routing communications traffic carrying signals in a communications network transport node.

A first aspect of the invention provides a communications network transport node comprising an optical add-drop multiplexer and a packet switch. The optical add-drop multiplexer comprises a plurality of optical signal processing apparatus and electrical signal routing apparatus. Each optical signal processing apparatus comprises an optical input, an optical output, optical to electrical signal conversion apparatus, and electrical to optical signal conversion apparatus. Each optical input is arranged to receive a plurality of input optical channel signals. Each input optical channel signal has a different one of said plurality of channel wavelengths and each carries respective communications traffic. Each optical to electrical signal conversion apparatus is arranged to receive said input optical channel signals and to convert each said input optical channel signal into a corresponding input radio frequency modulated electrical channel signal. Each electrical to optical signal conversion apparatus is arranged to receive a plurality of output radio frequency modulated electrical channel signals each carrying respective communications traffic and to convert each said output radio frequency modulated electrical channel signal into a corresponding output optical channel signal each having a different one of said plurality of channel wavelengths. Each electrical to optical signal conversion apparatus is further arranged to provide each said output optical channel signal to said optical output. The electrical signal routing apparatus is arranged to receive said input radio frequency modulated electrical channel signals. The electrical signal routing apparatus comprises a plurality of electrical add inputs and a plurality of electrical drop outputs. Each electrical add input is arranged to receive a respective further radio frequency modulated electrical channel signal carrying respective communications traffic. The electrical signal routing apparatus is further arranged to determine which of said input radio frequency modulated electrical channel signals are to be dropped and to route each said signal to be dropped to a selected said electrical drop output. The electrical signal routing apparatus is further arranged to determine which of said input radio frequency modulated electrical channel signals are to be transmitted and to route each said signal to be transmitted to a selected said electrical to optical signal conversion apparatus. The electrical signal routing apparatus is further arranged to receive a said further radio frequency modulated electrical channel signal and route said further radio frequency modulated electrical channel signal to a selected said electrical to optical signal conversion apparatus. The packet switch is arranged to receive at least one electrical channel signal from at least one said electrical drop output and is further arranged to provide at least one further electrical channel signal to be radio frequency modulated and received by a respective said electrical add input.

The communications network transport node may provide integration of a dense wavelength division multiplexed (DWDM) transport system with a radio frequency (RF) physical sub-layer based on analog RF channel switching. The RF sub-layer may enable very high bit rate signals within the electrical domain. The communications network transport node may enable flexible and scalable add/drop switching and may enable colourless and directionless add/drop switching. The node may further enable dynamic path set up for the radio frequency modulated electrical channel signals. The node may also enable an optical channel signal to be received at a first wavelength and to be switched onto a different wavelength for onward transmission. The node may therefore provide wavelength conversion capability which may reduce constraints on routing and wavelength assignment within a communications network to which the node is connected, and may therefore enable more flexible management of the available bandwidth with the network. In an embodiment, the optical to electrical signal conversion apparatus comprises a coherent receiver.

In an embodiment, electrical to optical signal conversion apparatus comprises a coherent transmitter.

In an embodiment, said electrical signal routing apparatus is further arranged to split each said input radio frequency modulated electrical channel signal into a plurality of radio frequency modulated electrical sub-channel signals each carrying a respective portion of said communications traffic. Each said electrical add input is arranged to receive a respective further radio frequency modulated electrical sub-channel signal. Said electrical signal routing apparatus is further arranged to selectively combine said radio frequency modulated electrical sub-channel signals to be transmitted and said further radio frequency modulated electrical sub-channel signals to form respective output electrical channel signals and to deliver each said output electrical channel signal to a respective said electrical to optical signal conversion apparatus. Splitting each input RF modulated electrical channel signal into a plurality of RF modulated electrical sub-channel signals provides a sub-wavelength switching layer within the optical add-drop multiplexer (OADM) between the packet switch and the optical layer of the node. The sub-wavelength switching layer may enable directionless and colourless add/drop switching within the node. The node may also enable an optical channel signal to be received at a first wavelength and to be switched onto a different wavelength for onward transmission. The node may further enable dynamic path set up for the radio frequency modulated electrical channel signals. The node may enable RF sub-channels to be added/dropped to/from each optical output/input of the node and may enable RF sub-channels to be interconnected to different wavelengths through the RF sub-layer provided by the electrical signal routing apparatus.

In an embodiment, said electrical signal routing apparatus comprises a plurality of electrical signal processing apparatus, a plurality of electrical signal drop outputs, a plurality of electrical signal add inputs, and electrical switch apparatus. Each electrical signal processing apparatus comprises a plurality of electrical signal splitters, and a plurality of electrical signal combiners. Each electrical signal splitters is arranged to receive a respective said input radio frequency modulated electrical channel signal and to split said input radio frequency modulated electrical channel signal into a plurality of radio frequency modulated electrical sub-channel signals. Each electrical signal combiner is arranged to receive a plurality of radio frequency modulated electrical sub-channel signals and further radio frequency modulated electrical sub-channel signals and to combine said signals to form a corresponding said output electrical channel signal. The electrical switch apparatus is coupled between said electrical signal splitters, said drop outputs, said add inputs and said electrical signal combiners of each said electrical signal processing apparatus. The electrical switch apparatus is arranged to receive from each electrical signal processing apparatus each said radio frequency modulated electrical sub-channel signal to be transmitted and to receive any further radio frequency modulated electrical sub-channel signals from one or more of said add inputs. The electrical switch apparatus is further arranged to route each said signal to a respective said electrical signal combiner.

The electrical signal routing apparatus may thereby provide the node with grooming capability at the physical layer without requiring an increase in capacity or of the number of add inputs and drop outputs interfacing with the packet switch. The node may therefore aggregate add and transit RF sub-channel signals into a single output optical channel signal, at a single wavelength, which may optimise utilisation of the wavelength capacity of a communications network to which the node is connected.

In an embodiment, the electrical switch apparatus comprises an analog switch. In an embodiment, the electrical switch apparatus comprises an analog crosspoint switch.

In an embodiment, the analog switch comprises a controller arranged to select a respective said electrical signal combiner for each said radio frequency modulated electrical sub-channel signal. Each electrical signal combiner is coupled to a said electrical to optical conversion apparatus. The controller may select an output optical signal channel wavelength for a radio frequency modulated electrical sub-channel signal and may therefore switch the wavelength of the optical channel on which communications traffic is being carried.

In an embodiment, each said optical signal processing apparatus is arranged to receive a wavelength multiplexed input optical signal comprising a plurality of optical channel signals. Each said optical signal processing apparatus further comprises an optical signal splitter, a demultiplexer and an optical signal combiner. The optical signal splitter is arranged to receive said wavelength multiplexed input optical signal and to power split said input optical signal into a first part and a second part. The demultiplexer is arranged to receive said first part and to demultiplex said first part into its constituent optical channel signals. The demultiplexer is further arranged to transmit each of said optical channel signals which is to be switched. The optical signal combiner is arranged to receive said output optical channel signals and a said second part of a further said input optical signal and to select from said second part each transit optical channel signal. The optical signal combiner is further arranged to combine said output optical channel signals and each transit optical channel signal to form a wavelength multiplexed output optical signal and to provide said output optical signal to said optical signal output. The node may therefore select and optically route transit optical signal channels without requiring them to under go O-E and E-O conversion and without them needing to be processed by the electrical signal routing apparatus. This may preserve the processing capacity of the RF sub-layer of the switch for handling channels which are to be dropped and/or added.

In an embodiment, each said optical signal processing apparatus is arranged to receive a wavelength multiplexed input optical signal comprising a plurality of optical channel signals. Each said optical signal processing apparatus further comprises a wavelength selective optical signal splitter and a demultiplexer. The wavelength selective optical signal splitter is arranged to receive said wavelength multiplexed input optical signal and to select a sub-band of said input optical signal comprising a sub-set of said optical channel signals. The demultiplexer is arranged to receive said sub-band input optical signal and to demultiplex said sub-band input optical signal into its constituent optical channel signals. Each optical signal processing apparatus therefore only operates on a pre-selected set of channel wavelengths.

In an embodiment, the wavelength selective optical signal splitter is a band split filter.

In an embodiment, the optical add-drop multiplexer further comprises a multiplexer and a demultiplexer. The demultiplexer is arranged to receive a wavelength multiplexed input optical signal comprising a plurality of optical channel signals and to demultiplex said input optical signal into a plurality of sub-band input optical signals. Each sub-band input optical signal comprises a different sub-set of said plurality of optical channel signals. The demultiplexer is further arranged to route a respective said sub-band input optical signal to each said optical signal processing apparatus and to route at least one other said sub-band input optical signal to said multiplexer. This may reduce the complexity of the node for transit traffic which does not require O-E and E-O conversion and fixed wavelengths may be allocated within the Path Computation Engine of the communications network for transit traffic.

In an embodiment, the node further comprises an electrical signal combiner and electrical signal modulation apparatus. The electrical signal combiner is arranged to receive from said packet switch a plurality of electrical traffic signals each carrying respective communications traffic and to combine said electrical traffic signals to form a said further electrical sub-channel signal. The electrical signal modulation apparatus is arranged to radio frequency modulate each said further electrical sub-channel signal to form a corresponding radio frequency modulated electrical sub-channel signal to be received by a respective add input. The node may thereby multiplex traffic signals received in the electrical domain from the packet switch into a single RF modulated electrical sub-channel signal to be added at the node. In an embodiment, said traffic has a first bit rate and said electrical signal combiner comprises transmission apparatus arranged to multiplex and map said traffic into a said further electrical sub-channel signal having a second, higher bit rate equal to a bit rate of a said output optical signal. This may enable the node to groom traffic received from the packet switch in the physical layer without requiring an increase in the capacity of the electrical signal routing apparatus or of the number of physical interfaces (add inputs) between the packet switch and the electrical signal routing apparatus.

In an embodiment, the transmission apparatus comprises a multiplexing transponder and the electrical signal modulation apparatus comprises a digital signalling processor.

In an embodiment, the packet switch is arranged for communication with an optical transport network layer of a communications network.

A second aspect of the invention provides an optical add-drop multiplexer comprising a plurality of optical signal processing apparatus and electrical signal routing apparatus. Each optical signal processing apparatus comprises an optical input, an optical output, optical to electrical signal conversion apparatus, and electrical to optical signal conversion apparatus. Each optical input is arranged to receive a plurality of input optical channel signals. Each input optical channel signal has a different one of said plurality of channel wavelengths and each carries respective communications traffic. Each optical to electrical signal conversion apparatus is arranged to receive said input optical channel signals and to convert each said input optical channel signal into a corresponding input radio frequency modulated electrical channel signal. Each electrical to optical signal conversion apparatus is arranged to receive a plurality of output radio frequency modulated electrical channel signals each carrying respective communications traffic and to convert each said output radio frequency modulated electrical channel signal into a corresponding output optical channel signal each having a different one of said plurality of channel wavelengths. Each electrical to optical signal conversion apparatus is further arranged to provide each said output optical channel signal to said optical output. The electrical signal routing apparatus is arranged to receive said input radio frequency modulated electrical channel signals. The electrical signal routing apparatus comprises a plurality of electrical add inputs and a plurality of electrical drop outputs. Each electrical add input is arranged to receive a respective further radio frequency modulated electrical channel signal carrying respective communications traffic. The electrical signal routing apparatus is further arranged to determine which of said input radio frequency modulated electrical channel signals are to be dropped and to route each said signal to be dropped to a selected said electrical drop output. The electrical signal routing apparatus is further arranged to determine which of said input radio frequency modulated electrical channel signals are to be transmitted and to route each said signal to be transmitted to a selected said electrical to optical signal conversion apparatus. The electrical signal routing apparatus is further arranged to receive a said further radio frequency modulated electrical channel signal and route said further radio frequency modulated electrical channel signal to a selected said electrical to optical signal conversion apparatus.

The OADM may provide integration of a dense wavelength division multiplexed (DWDM) transport system with a radio frequency (RF) physical sub-layer based on analog RF channel switching. The RF sub-layer may enable very high bit rate signals within the electrical domain. The OADM may enable flexible and scalable add/drop switching and may enable colourless and directionless add/drop switching. The OADM may further enable dynamic path set up for the radio frequency modulated electrical channel signals. The OADM may also enable an optical channel signal to be received at a first wavelength and to be switched onto a different wavelength for onward transmission. The OADM may therefore provide wavelength conversion capability which may reduce constraints on routing and wavelength assignment within a communications network to which the OADM is connected, and may therefore enable more flexible management of the available bandwidth with the network. In an embodiment, the optical to electrical signal conversion apparatus comprises a coherent receiver.

In an embodiment, electrical to optical signal conversion apparatus comprises a coherent transmitter.

In an embodiment, said electrical signal routing apparatus is further arranged to split each said input radio frequency modulated electrical channel signal into a plurality of radio frequency modulated electrical sub-channel signals each carrying a respective portion of said communications traffic. Each said electrical add input is arranged to receive a respective further radio frequency modulated electrical sub-channel signal. Said electrical signal routing apparatus is further arranged to selectively combine said radio frequency modulated electrical sub-channel signals to be transmitted and said further radio frequency modulated electrical sub-channel signals to form respective output electrical channel signals and to deliver each said output electrical channel signal to a respective said electrical to optical signal conversion apparatus.

Splitting each input RF modulated electrical channel signal into a plurality of RF modulated electrical sub-channel signals provides a sub-wavelength switching layer within OADM. The sub-wavelength switching layer may enable directionless and colourless add/drop switching within the OADM. The OADM may also enable an optical channel signal to be received at a first wavelength and to be switched onto a different wavelength for onward transmission. The OADM may further enable dynamic path set up for the radio frequency modulated electrical channel signals. The OADM may enable RF sub-channels to be added/dropped to/from each optical output/input of the node and may enable RF sub-channels to be interconnected to different wavelengths through the RF sub-layer provided by the electrical signal routing apparatus.

In an embodiment, said electrical signal routing apparatus comprises a plurality of electrical signal processing apparatus, a plurality of electrical signal drop outputs, a plurality of electrical signal add inputs, and electrical switch apparatus. Each electrical signal processing apparatus comprises a plurality of electrical signal splitters, and a plurality of electrical signal combiners. Each electrical signal splitters is arranged to receive a respective said input radio frequency modulated electrical channel signal and to split said input radio frequency modulated electrical channel signal into a plurality of radio frequency modulated electrical sub-channel signals. Each electrical signal combiner is arranged to receive a plurality of radio frequency modulated electrical sub-channel signals and further radio frequency modulated electrical sub-channel signals and to combine said signals to form a corresponding said output electrical channel signal. The electrical switch apparatus is coupled between said electrical signal splitters, said drop outputs, said add inputs and said electrical signal combiners of each said electrical signal processing apparatus. The electrical switch apparatus is arranged to receive from each electrical signal processing apparatus each said radio frequency modulated electrical sub-channel signal to be transmitted and to receive any further radio frequency modulated electrical sub-channel signals from one or more of said add inputs. The electrical switch apparatus is further arranged to route each said signal to a respective said electrical signal combiner.

The electrical signal routing apparatus may thereby provide the OADM with grooming capability at the physical layer without requiring an increase in capacity or of the number of add inputs and drop outputs. The OADM may therefore aggregate add and transit RF sub-channel signals into a single output optical channel signal, at a single wavelength, which may optimise utilisation of the wavelength capacity of a communications network to which the OADM is connected.

In an embodiment, the electrical switch apparatus comprises an analog switch. In an embodiment, the electrical switch apparatus comprises an analog crosspoint switch.

In an embodiment, the analog switch comprises a controller arranged to select a respective said electrical signal combiner for each said radio frequency modulated electrical sub-channel signal. Each electrical signal combiner is coupled to a said electrical to optical conversion apparatus. The controller may select an output optical signal channel wavelength for a radio frequency modulated electrical sub-channel signal and may therefore switch the wavelength of the optical channel on which communications traffic is being carried.

In an embodiment, each said optical signal processing apparatus is arranged to receive a wavelength multiplexed input optical signal comprising a plurality of optical channel signals. Each said optical signal processing apparatus further comprises an optical signal splitter, a demultiplexer and an optical signal combiner. The optical signal splitter is arranged to receive said wavelength multiplexed input optical signal and to power split said input optical signal into a first part and a second part. The demultiplexer is arranged to receive said first part and to demultiplex said first part into its constituent optical channel signals. The demultiplexer is further arranged to transmit each of said optical channel signals which is to be switched. The optical signal combiner is arranged to receive said output optical channel signals and a said second part of a further said input optical signal and to select from said second part each transit optical channel signal. The optical signal combiner is further arranged to combine said output optical channel signals and each transit optical channel signal to form a wavelength multiplexed output optical signal and to provide said output optical signal to said optical signal output. The OADM may therefore select and optically route transit optical signal channels without requiring them to under go O-E and E-O conversion and without them needing to be processed by the electrical signal routing apparatus. This may preserve the processing capacity of the RF sub-layer of the switch for handling channels which are to be dropped and/or added.

In an embodiment, each said optical signal processing apparatus is arranged to receive a wavelength multiplexed input optical signal comprising a plurality of optical channel signals. Each said optical signal processing apparatus further comprises a wavelength selective optical signal splitter and a demultiplexer. The wavelength selective optical signal splitter is arranged to receive said wavelength multiplexed input optical signal and to select a sub-band of said input optical signal comprising a sub-set of said optical channel signals. The demultiplexer is arranged to receive said sub-band input optical signal and to demultiplex said sub-band input optical signal into its constituent optical channel signals. Each optical signal processing apparatus therefore only operates on a pre-selected set of channel wavelengths.

In an embodiment, the wavelength selective optical signal splitter is a band split filter.

In an embodiment, the optical add-drop multiplexer further comprises a multiplexer and a demultiplexer. The demultiplexer is arranged to receive a wavelength multiplexed input optical signal comprising a plurality of optical channel signals and to demultiplex said input optical signal into a plurality of sub-band input optical signals. Each sub-band input optical signal comprises a different sub-set of said plurality of optical channel signals. The demultiplexer is further arranged to route a respective said sub-band input optical signal to each said optical signal processing apparatus and to route at least one other said sub-band input optical signal to said multiplexer. This may reduce the complexity of the OADM for transit traffic which does not require O-E and E-O conversion and fixed wavelengths may be allocated within the Path Computation Engine of the communications network for transit traffic.

A third aspect of the invention provides a method of routing communications traffic carrying signals in a communications network transport node. The method comprises:

a. receiving a plurality of input optical channel signals each carrying respective communications traffic;

b. converting each said input optical channel signal into a corresponding input radio frequency modulated electrical channel signal;

c. determining which of said input radio frequency modulated electrical channel signals are to be dropped and routing each said signal to be dropped to an electrical signal drop output for delivery to a packet switch;

d. determining which of said input radio frequency modulated electrical channel signals are to be transmitted and converting each said signal to be transmitted into an output optical channel signal;

e. receiving a plurality of further radio frequency modulated electrical channel signals each carrying respective communications traffic and converting each said signal into an output optical channel signal;

f. delivering each said output optical channel signal to a respective optical output.

Flexible and scalable add/drop switching and colourless and directionless add/drop switching may be enabled by the method. The method may further enable dynamic path set up for the radio frequency modulated electrical channel signals. The method may also enable an optical channel signal to be received at a first wavelength and to be switched onto a different wavelength for onward transmission. The method may therefore provide wavelength conversion capability which may reduce constraints on routing and wavelength assignment within a communications network, and may therefore enable more flexible management of the available bandwidth within the network. In an embodiment, step b. further comprises splitting each said input radio frequency modulated electrical channel signal into a plurality of input radio frequency modulated electrical sub-channel signals. Step c. comprises determining which of said input radio frequency modulated electrical sub-channel signals are to be dropped and routing each said sub-channel signal to be dropped to an electrical signal drop output. Step e. initially comprises receiving a plurality of further radio frequency modulated electrical sub-channel signals each carrying respective communications traffic. Step e. comprises selectively combining sub-sets of said plurality of said input radio frequency modulated electrical sub-channel signals and said further radio frequency modulated electrical sub-channel signals to form respective said output electrical channel signals and converting each said output electrical channel signal into a corresponding output optical channel signal.

Splitting each input RF modulated electrical channel signal into a plurality of RF modulated electrical sub-channel signals may enable sub-wavelength switching to be implemented within the node. The sub-wavelength switching may enable directionless and colourless add/drop switching within the node. An optical channel signal may be received at a first wavelength and switched onto a different wavelength for onward transmission. RF sub-channels may be added/dropped to/from each optical output/input of the node and RF sub-channels may be interconnected to different wavelengths. Communications traffic may be groomed at the physical layer without requiring an increase in capacity or of the number of add inputs and drop outputs in the node. Add and transit RF sub-channel signals may be aggregated into a single output optical channel signal, at a single wavelength, which may optimise utilisation of the wavelength capacity of a communications network.

In an embodiment, the method further comprises, prior to step a., receiving a wavelength multiplexed input optical signal comprising a plurality of optical channel signals and splitting said input optical signal into a first part and a second part. The method further comprises demultiplexing said first part into its constituent optical channel signals. The method further comprises selecting each of said constituent optical channel signals which is to be switched. The method further comprises selecting from said second part each transit optical channel signal. The method further comprises combining said output optical channel signals and each transit optical channel signal to form a wavelength multiplexed output optical signal and providing said output optical signal to said optical signal output. Transit optical signal channels may therefore be routed without requiring them to under go O-E and E-O conversion and without them needing to be processed in the electrical domain. This may preserve electrical processing for handling channels which are to be dropped and/or added.

In an embodiment, the method further comprises, prior to step e., receiving from said packet switch a plurality of electrical traffic signals each carrying respective communications traffic and combining said electrical traffic signals to form a said further electrical sub-channel signal. The method further comprises applying radio frequency modulation to each said further electrical sub-channel signal to form a corresponding radio frequency modulated electrical sub-channel signal to be received by a respective add input.

Traffic signals received in the electrical domain may thus be multiplexed into a single RF modulated electrical sub-channel signal to be added at the node.

In an embodiment, said electrical traffic signals have a first bit rate and the method further comprises multiplexing and mapping said traffic into a said further electrical sub-channel signal having a second, higher bit rate equal to a bit rate of a said output optical signal. This may enable grooming of received traffic to be added in the physical layer of the node without requiring an increase in the capacity of the electrical signal routing apparatus or of the number of physical interfaces (add inputs).

A fourth aspect of the invention provides a data carrier having computer readable instructions embodied therein. The said computer readable instructions are for providing access to resources available on a processor. The computer readable instructions comprise instructions to cause the processor to perform any of the above steps of the method of routing communications traffic carrying signals in a communications network transport node.

Embodiments of the invention will now be described, by way of example only, with reference to the accompanying drawings.

### BRIEF DESCRIPTION OF THE DRAWINGS

FIG. 1 is a schematic representation of a communications network transport node according to a first embodiment of the invention;

FIG. 2 is a schematic representation of a communications network transport node according to a second embodiment of the invention;

FIG. 3 is a schematic representation of a communications network transport node according to a third embodiment of the invention;

FIG. 4 shows the spectra of the electrical traffic signals received from the packet switch of FIG. 3;

FIG. 5 is a schematic representation of an optical add-drop multiplexer according to a fourth embodiment of the invention, which may be used in the communications network transport node of any of FIGS. 1 to 3;

FIG. 6 is a schematic representation of an optical add-drop multiplexer according to a fifth embodiment of the invention, which may be used in the communications network transport node of any of FIGS. 1 to 3;

FIG. 7 is a schematic representation of an optical add-drop multiplexer according to a sixth embodiment of the invention, which may be used in the communications network transport node of any of FIGS. 1 to 3;

FIG. 8 is a schematic representation of an optical add-drop multiplexer according to a seventh embodiment of the invention, which may be used in the communications network transport node of any of FIGS. 1 to 3;

FIG. 9 is a schematic representation of an optical add-drop multiplexer according to an eighth embodiment of the invention, which may be used in the communications network transport node of any of FIGS. 1 to 3;

FIG. 10 is a flow chart of the steps of a method of routing communications traffic carrying signals in a communications network transport node according to a ninth embodiment of the invention;

FIG. 11 is a flow chart of the steps of a method of routing communications traffic carrying signals in a communications network transport node according to a tenth embodiment of the invention;

FIG. 12 is a flow chart of the steps of a method of routing communications traffic carrying signals in a communications network transport node according to an eleventh embodiment of the invention; and

FIG. 13 is a flow chart of the steps of a method of routing communications traffic carrying signals in a communications network transport node according to a twelfth embodiment of the invention.

### DETAILED DESCRIPTION

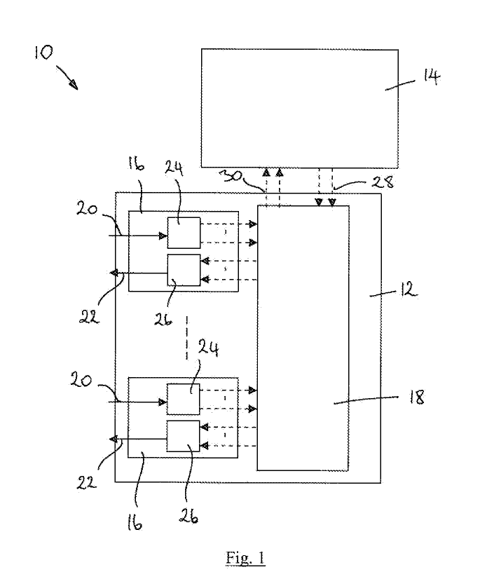

Referring to FIG. 1, a first embodiment of the invention provides a communications network transport node 10 comprising an optical add-drop multiplexer (OADM) 12 and a packet switch 14.

The OADM 12 comprises a plurality of optical signal processing apparatus 16 (only two are shown in the figure for reasons of clarity but it will be appreciated by the person skilled in the art that the OADM 12 will in practice comprise more optical signal processing apparatus 16) and electrical signal routing apparatus 18.

Each optical signal processing apparatus 16 comprises an optical input 20 arranged to receive a plurality of input optical channel signals. Each input optical channel signal has a different one of a plurality of channel wavelengths and each input optical channel signal carries respective communications traffic. Each optical signal processing apparatus 16 also comprises an optical output 22.

Each optical signal processing apparatus 16 comprises optical-to-electrical (O-E) signal conversion apparatus 24 and electrical to optical (E-O) signal conversion apparatus 26. Each O-E signal conversion apparatus 24 is arranged to receive the input optical channel signals and to convert each input optical channel signal into a corresponding input radio frequency (RF) modulated electrical channel signal. The E-O signal conversion apparatus 26 is arranged to receive a plurality of output RF modulated electrical channel signals each carrying respective communications traffic. The E-O signal conversion apparatus 26 is arranged to convert each output RF modulated electrical channel signal into a corresponding output optical channel signal. Each output optical channel signal has a different one of the plurality of channel wavelengths. Each E-O signal conversion apparatus 26 is arranged to provide each output optical channel signal to the optical output 22.

The electrical signal routing apparatus 18 is arranged to receive the input RF modulated electrical channel signals and comprises a plurality of electrical add inputs 28 and a plurality of electrical drop outputs 30. Each electrical add input 28 is arranged to receive a respective further RF modulated electrical channel signal carrying respective communications traffic. The electrical signal routing apparatus 18 is arranged to determine which of the input RF modulated electrical channel signals are to be dropped and to route each signal which is to be dropped to a selected electrical drop output 30. The electrical signal routing apparatus 18 is further arranged to determine which of the input RF modulated electrical channel signals are to be transmitted and to route each signal which is to be transmitted to a selected E-O signal conversion apparatus 26. The electrical signal routing apparatus 18 is further arranged to receive a further RF modulated electrical channel signal at an electrical add input 28 and to route the further RF modulated electrical channel signal to a selected E-O signal conversion apparatus 26.

The packet switch 14 is arranged to receive one or more electrical channel signals to be dropped from respective ones of the electrical drop outputs 30. The packet switch 14 is further arranged to deliver one or more further electrical channel signals to be RF modulated and received by respective ones of the electrical add inputs 28.

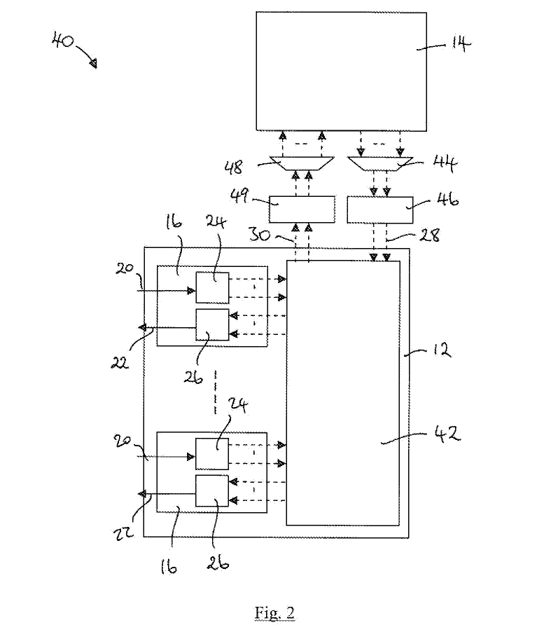

A communications network transport node 40 according to a second embodiment of the invention is shown in FIG. 2. The node 40 of this embodiment is similar to the node 10 of FIG. 1, with the following modifications. The same reference numbers are retained for corresponding features.

In this embodiment, the electrical signal routing apparatus 42 is further arranged to split each input RF modulated electrical channel signal into a plurality of RF modulated sub-channel signals each carrying a respective portion of the communications traffic of the originating input electrical channel signal. The electrical signal routing apparatus 42 is arranged to determine which of the input RF modulated electrical sub-channel signals are to be dropped and to route each RF modulated sub-channel signal to be dropped to a selected electrical drop output 30. Each electrical add input 28 is arranged to receive a respective further RF modulated electrical sub-channel signal carrying communications traffic.

The electrical signal routing apparatus 42 is further arranged to selectively combine input RF modulated electrical sub-channel signals to be transmitted and further RF modulated electrical sub-channel signals to form output electrical channel signals having a common output direction. The electrical signal routing apparatus 42 is further arranged to deliver each output electrical channel signal to a respective E-O signal conversion apparatus 26.

The node 40 additionally comprises an electrical signal combiner 44 and an electrical signal modulation apparatus 46 provided between the packet switch 14 and the electrical add inputs 28. The electrical signal combiner 44 is arranged to receive a plurality of electrical traffic signals from the packet switch 14, each traffic signal carrying respective communications traffic. The electrical signal combiner 44 is arranged to combine the electrical traffic signals to form a further electrical sub-channel signal. The electrical signal combiner 44 is therefore arranged to combine sets of electrical traffic signals to form respective electrical sub-channel signals for delivery to respective electrical add inputs 28. The electrical signal modulation apparatus 46 is arranged to RF modulate each further electrical sub-channel signal to form a corresponding RF modulated electrical sub-channel signal for delivery to a respective electrical add input 28.

The node 40 additionally comprises an electrical signal de-multiplexer 48 and an electrical signal de-modulation apparatus 49 provided between the packet switch 14 and the electrical drop outputs 30.

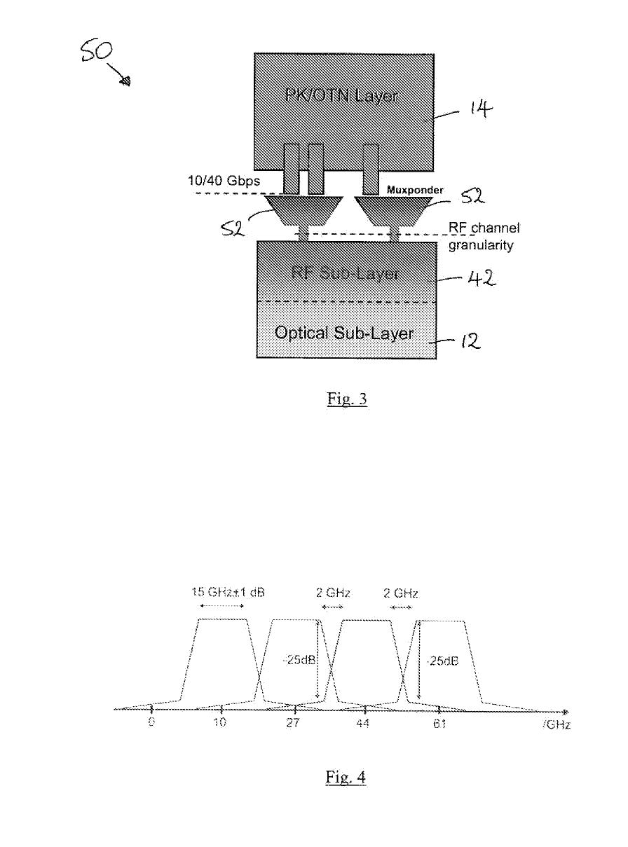

A communications network transport node 50 according to a third embodiment of the invention is shown in FIG. 3. The node 50 of this embodiment is similar to the node 40 of FIG. 2, with the following modifications. The same reference numbers are retained for corresponding features.

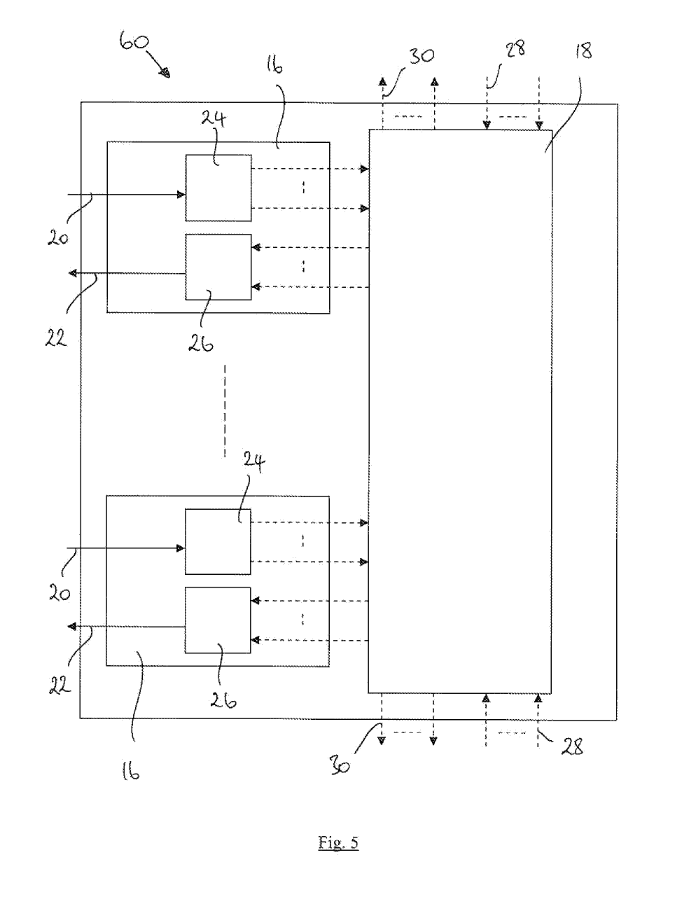

In this embodiment the electrical signal combiner comprises a multiplexed transponder (muxponder) 52 which is arranged to perform time division multiplexing of lower rate electrical traffic signals into a higher rate further RF modulated electrical sub-channel signal. For example, the muxponders 52 may multiplex and map multiple electrical traffic signals into a higher bit rate electrical sub-channel signal, for example 10 Gigabit Ethernet (GE), optical data unit (ODU)-2 signal or ODU-3 signals (as defined in ITU-T Recommendation G.709). For example, as shown in FIG. 4, a 112 Gbps RF sub-channel signal can be formed by multiplexing and mapping four 14 Gbaud electrical traffic signals (that is a 14 Gbaud channel with 16QAM and dual polarization schemes), having the channel spectra within a 66 GHz bandwidth spectrum as shown in FIG. 4. Finer granularities may be obtained by using more RF sub-channels within the same bandwidth.

In this embodiment, the muxponder 52 includes the electrical signal modulation apparatus, which in this example comprises a digital signalling processor.

It will be appreciated that embodiments in which fine RF channel granularities are used for the electrical traffic signals, that fit the 10GE and/or ODU-2 bit rate, will not require data multiplexing and mapping, and will therefore not require a muxponder. In such an embodiment the interconnection between the packet switch and the electrical signal routing apparatus is simplified and the node may be of lower cost.

An optical add-drop multiplexer (OADM) 60 according to a fourth embodiment of the invention is shown in FIG. 5. The OADM 60 has the same structure as the OADM 12 of FIG. 1, and the same reference numbers are retained for corresponding features.

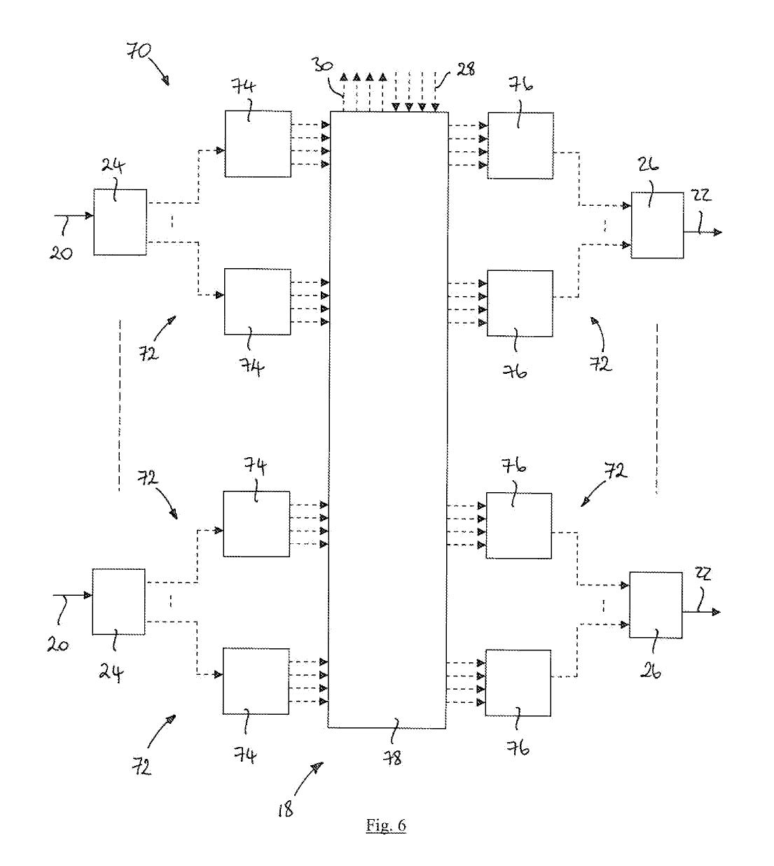

An OADM 70 according to a fifth embodiment of the invention is shown in FIG. 6. It will be appreciated that the OADM 70 of this embodiment may be used in any of the communications network transport nodes 10, 40, 50 shown in FIGS. 1 to 3. The OADM 70 of this embodiment is similar to the OADM 60 of FIG. 5 and the same reference numbers are retained for corresponding features.

In this embodiment the electrical signal routing apparatus 18 comprises a plurality of electrical signal processing apparatus 72. Each electrical signal processing apparatus 72 comprises a plurality of electrical signal splitters 74 (only two are shown for reasons of clarity but it will be appreciated that a greater number may be used in practice). Each electrical signal splitter 74 is arranged to receive a respective input RF modulated electrical channel signal and to split the input signal into a plurality, in this example four, of RF modulated electrical sub-channel signals. Therefore each input optical channel signal carries four RF channels. Each electrical signal processing apparatus 72 further comprises a corresponding plurality of electrical signal combiners 76. Each electrical signal combiner 76 is arranged to receive a plurality, in this example four, of electrical sub-channel signals and further electrical sub-channel signals. Each electrical signal combiner is arranged to combine a plurality of electrical sub-channel signals and further electrical sub-channel signals having a common output direction to form a corresponding output electrical channel signal.

The electrical signal routing apparatus 18 further comprises electrical switch apparatus 78, which in this embodiment comprises an analog crosspoint switch, coupled between the electrical signal splitters 74, the electrical signal combiners 76, the drop outputs 30 and the add inputs 28. The electrical switch apparatus 78 is arranged to receive from each electrical signal processing apparatus 72 each RF modulated electrical sub-channel signal which is to be transmitted and to route each said signal to a respective electrical signal combiner 76. The electrical switch apparatus 78 is also arranged to receive any further RF modulated electrical sub-channel signals from the add inputs 28 and to route each said signal to a respective electrical signal combiner 76.

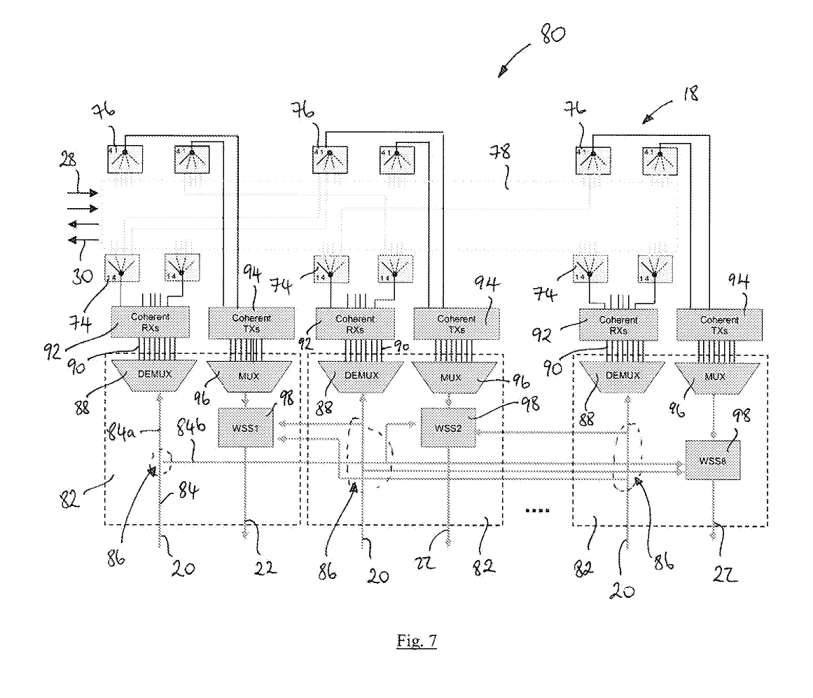

An OADM 80 according to a sixth embodiment of the invention is shown in FIG. 7. The OADM 80 of this embodiment may be used in any of the communications network transport nodes 10, 40, 50 shown in FIGS. 1 to 3. The OADM 80 of this embodiment is similar to the OADM 70 of FIG. 6, with the following modifications. The same reference numbers are retained for corresponding features.

In this embodiment each optical signal processing apparatus 82 is arranged to receive a wavelength multiplexed input optical signal 84 comprising a plurality of optical channel signals. Each optical signal processing apparatus 82 further comprises an optical signal splitter 86 which is arranged to receive the wavelength multiplex input optical signal. The optical signal splitter 86 is arranged to power split the input optical signal into a first part 84a and a second part 84b.

Each optical signal processing apparatus further comprises a demultiplexer 88 which is arranged to receive the first part of the input optical signal 84a and to demultiplex the signal into its constituent optical channel signals 90. The demultiplexer 88 is further arranged to transmit each of the optical channel signals which is to be switched, so that only those channels which are to be dropped or which are to have their optical channel wavelength changed are transmitted to the electrical switch apparatus 78.

The O-E signal conversion apparatus of this embodiment comprises a coherent receiver 92 which is arranged to receive each of the constituent optical channel signals 90 from the first part of the input signal. The E-O signal conversion apparatus of this embodiment comprises a coherent transmitter 94 which is arranged to receive output electrical channel signals from the electrical switch apparatus 78 and to convert them into corresponding output optical channel signals.

Each optical signal processing apparatus 82 further comprises a multiplexer 96 arranged to receive the output optical channel signals from the coherent transmitter 94 and to multiplex the output optical channel signals.

Each optical signal processing apparatus 82 further comprises an optical signal combiner, which in this example takes the form of a wavelength selective switch (WSS) 98. Each WSS 98 is arranged to receive the multiplexed output optical signals from its respective multiplexer 96 and to receive the second part of the input optical signal from another of the optical signal processing apparatus 82. Each WSS 98 is arranged to select from a received second part each optical channel signal which is to be transmitted onwards without being dropped or having its wavelength changed, that is to say each transit optical channel signal. Each WSS 98 is arranged to combine the output optical signals and the transit optical channels signals to form a wavelength multiplexed output optical signal and to provide the output optical signal to the optical signal output 22.

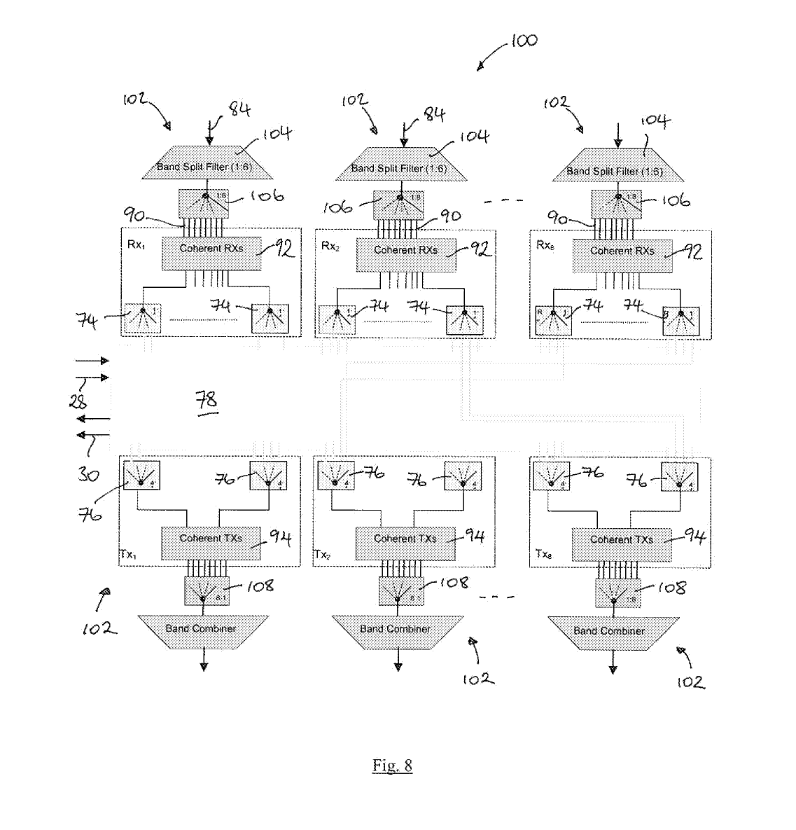

An OADM 100 according to a seventh embodiment of the invention is shown in FIG. 8. It will be appreciated that the OADM 100 of this embodiment may be used in any of the communications network transport nodes 10, 40, 50 shown in FIGS. 1 to 3. The OADM 100 of this embodiment is similar to the OADM 70 shown in FIG. 6, with the following modifications. The same reference numbers are retained for corresponding features.

In this embodiment each optical signal processing apparatus 102 is arranged to receive a wavelength multiplexed input optical signal 84 comprising a plurality of optical channel signals. Each optical signal processing apparatus 102 comprises a wavelength selective optical signal splitter, which in this example comprises a band split filter 104, which is arranged to receive the wavelength multiplexed input optical signal. The band split filter 104 is arranged to select a sub-band of the input optical signal comprising a subset of the optical channel signals. It will be appreciated that the band split filter 104 of each optical signal processing apparatus 102 is arranged to select a different subset of optical channel signals. Each optical signal processing apparatus 102 further comprises a demultiplexer 106 arranged to receive the sub-band input optical signal and to demultiplex the sub-band input optical signal into its constituent optical channel signals 90. Each optical signal processing apparatus further comprises an optical signal combiner 108 arranged to receive the output optical channel signals and to combine them into a first sub-band output optical signal.

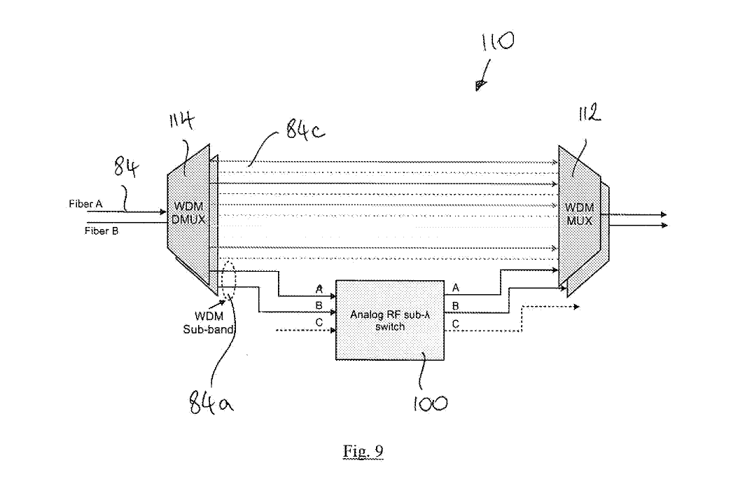

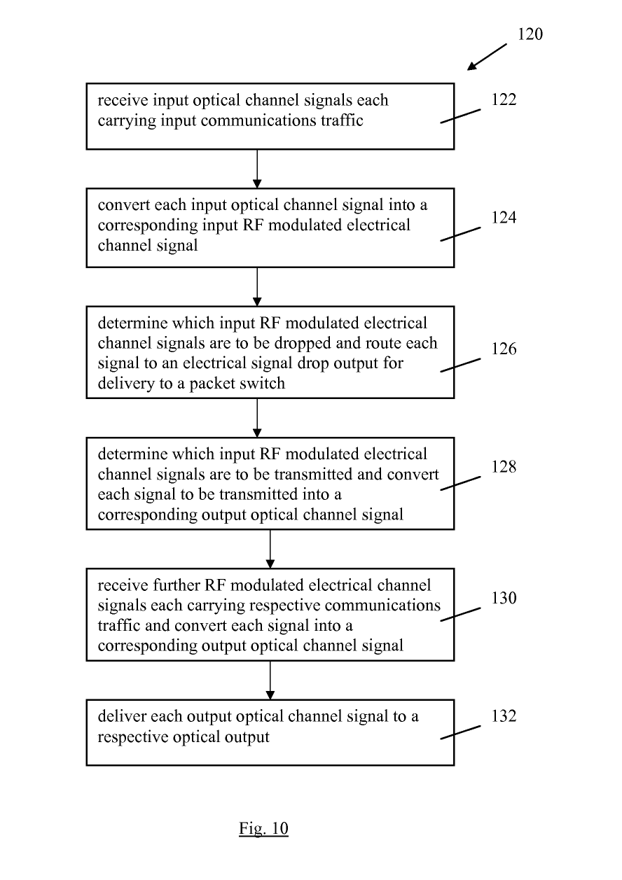

An optical add-drop multiplexer 110 according to an eighth embodiment of the invention is shown in FIG. 9. The OADM 110 of this embodiment may be used with any of the communications network transport nodes 10, 40, 50 as shown in FIGS. 1 to 3.

The OADM 110 of this embodiment is similar to the OADM 100 of FIG. 8, with the following modifications. The same reference numbers are retained for corresponding features. In this embodiment the OADM 110 further comprises a multiplexer 112 and a demultiplexer 114. The demultiplexer is arranged to receive a wavelength multiplexed input optical signal 84 comprising a plurality of optical channel signals. The demultiplexer 114 is arranged to demultiplex the input optical signal into a plurality of sub-band input optical signals each comprising a different sub-set of the optical channel signals. The demultiplexer 114 is arranged to route at least one sub-band input optical signal 84a to a respective optical signal processing apparatus 102. The demultiplexer 114 is further arranged to route at least one other sub-band input optical signal 84c directly to the multiplexer 112.

The OADM 110 is therefore able to route express, transit traffic in, for example, the second sub-band optical signal 84c, directly from the demultiplexer 114 to the multiplexer 112 and only to route a sub-band, for example sub-band 84a, to the optical signal processing apparatus 102 for conversion into RF modulated electrical channel signals, for routing within the electrical switch apparatus.

A ninth embodiment of the invention provides a method 120 of routing communications traffic carrying signals in a communications network transport node. The steps of the method are shown in FIG. 10.

The method 120 comprises:

a. receiving a plurality of input optical channel signals each carrying respective communications traffic 122;

b. converting each said input optical channel signal into a corresponding input RF modulated electrical channel signal 124;

c. determining which of said input RF modulated electrical channel signals are to be dropped and routing each said signal to be dropped to an electrical signal drop output for delivery to a packet switch 126;

d. determining which of said input RF modulated electrical channel signals are to be transmitted and converting each said signal to be transmitted into a corresponding output optical channel signal 128;

e. receiving a plurality of further RF modulated electrical channel signals each carrying respective communications traffic and converting each said signal into a corresponding output optical channel signal 130;

f. delivering each said output optical channel signal to a respective optical output 132.

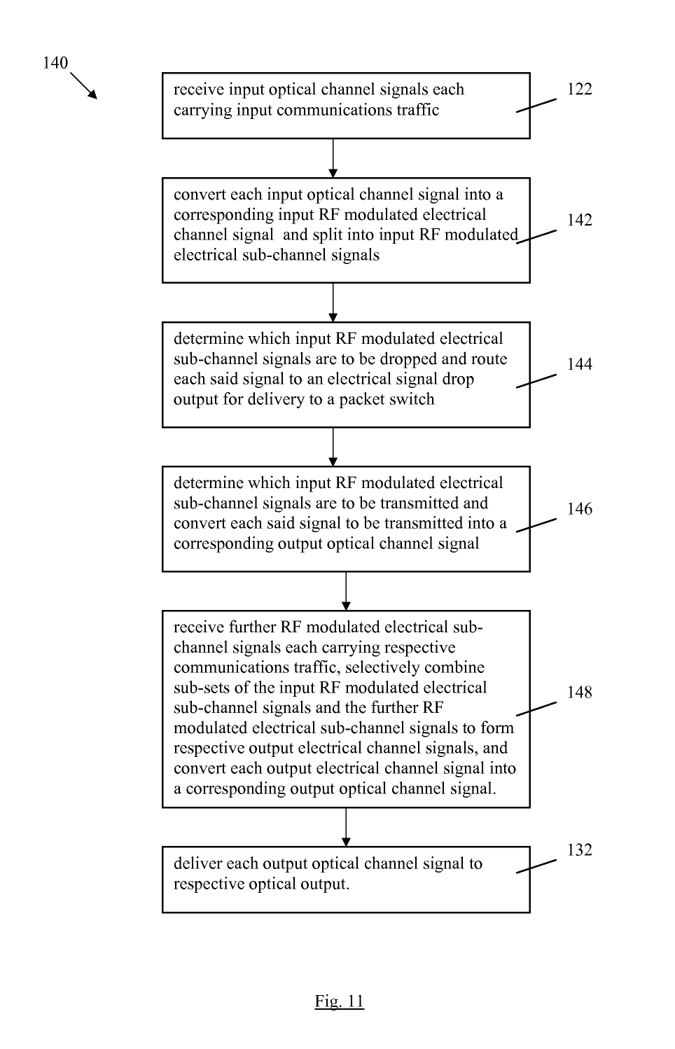

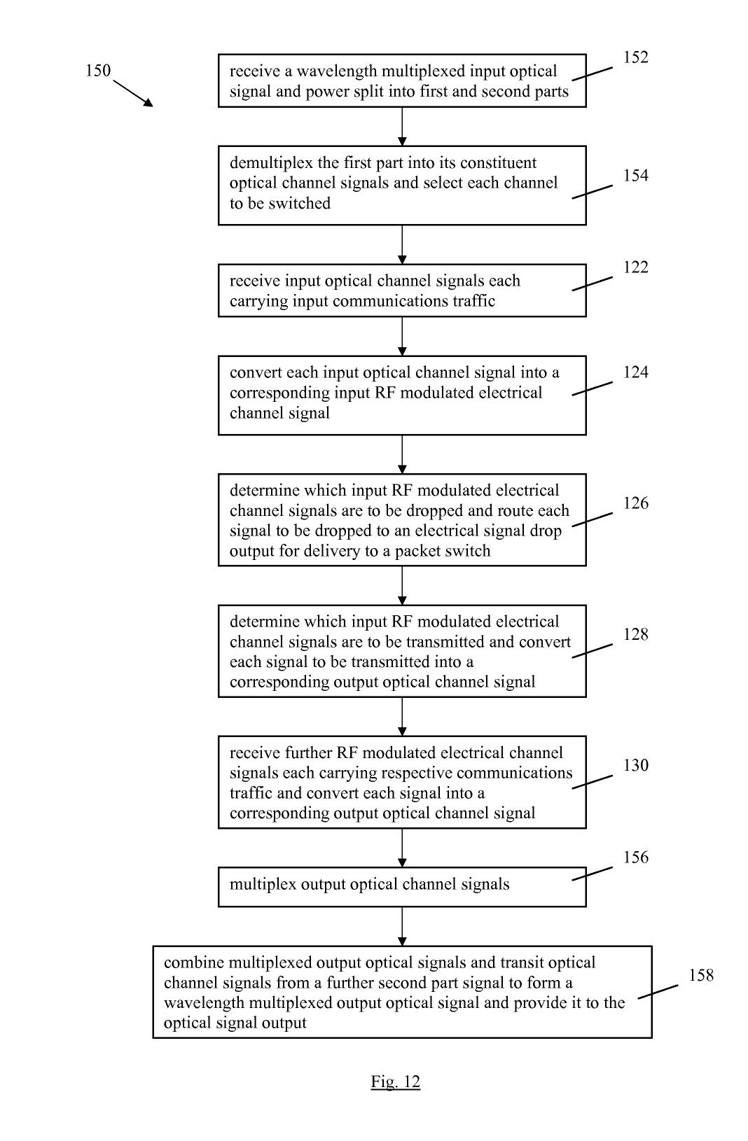

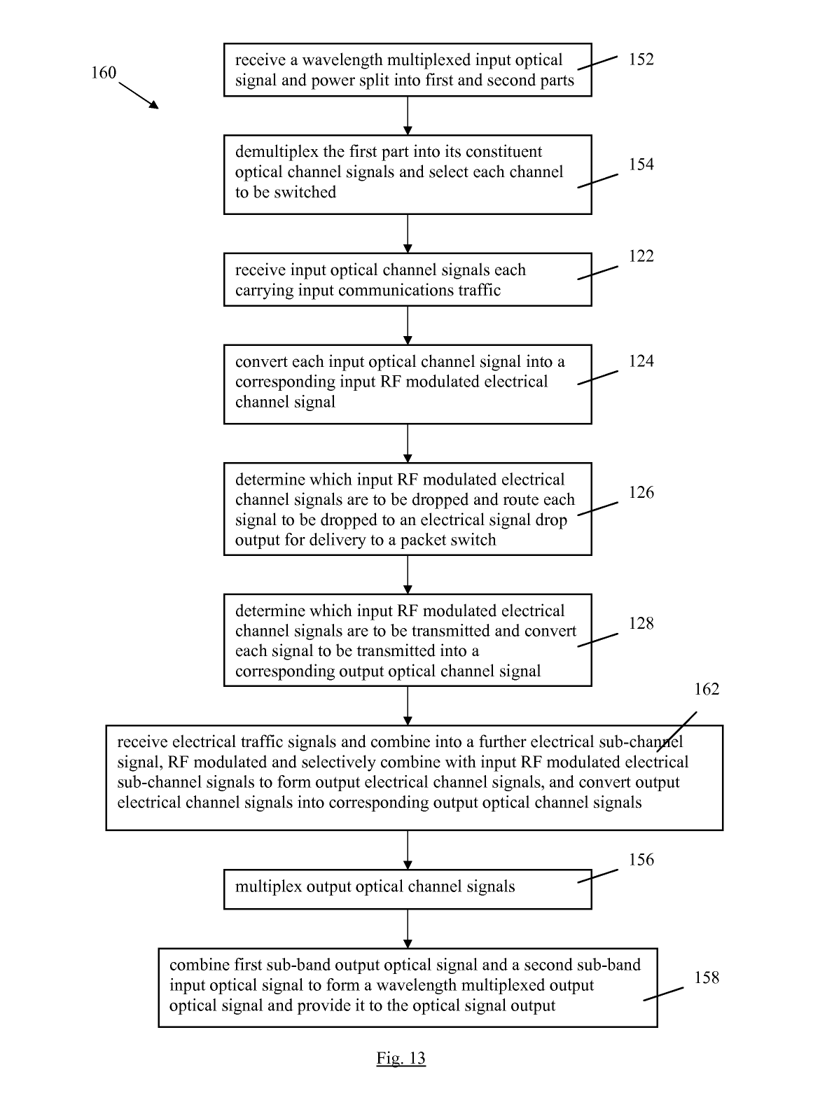

A tenth embodiment of the invention provides a method 140 of routing communications traffic carrying signals in a communications network transport node. The steps of the method are shown in FIG. 11.

The method 140 of this embodiment is similar to the method 120 of FIG. 10, with the following modifications. The same reference numbers are retained for corresponding steps.

In this embodiment, step b. 142 further comprises splitting each said input RF modulated electrical channel signal into a plurality of input RF modulated electrical sub-channel signals. Step c. 144 comprises determining which of the input RF modulated electrical sub-channel signals are to be dropped and routing each RF modulated sub-channel signal to be dropped to an electrical signal drop output 144. Step e. 148 initially comprises receiving a plurality of further RF modulated electrical sub-channel signals each carrying respective communications traffic. Step e. comprises selectively combining sub-sets of the input RF modulated electrical sub-channel signals and the further RF modulated electrical sub-channel signals to form respective output electrical channel signals. Step e. further comprises converting each output electrical channel signal into a corresponding output optical channel signal.

An eleventh embodiment of the invention provides a method 150 of routing communications traffic carrying signals in a communications network transport node. The steps of the method are shown in FIG. 11.

The method 150 of this embodiment is similar to the method 120 of FIG. 10, with the following modifications. The same reference numbers are retained for corresponding steps.

In this embodiment, the method 150 further comprises, prior to step a., receiving a wavelength multiplexed input optical signal comprising a plurality of optical channel signals and power splitting the input optical signal into a first and a second part 152 (although it will be appreciated that the input signal can be split into more than two parts). The method further comprises demultiplexing the first part of the input optical signal into its constituent optical channel signals 154 and selecting each of the optical channel signals which is to be switched 154.

The method 150 of this embodiment further comprises selecting the transit optical channel signals from a further second part signal (originating from a different input optical signal) and combining the output optical channel signals and the transit optical channel signals to form a wavelength multiplexed output optical signal 158. The output optical signal is then provided to the optical signal output.

A twelfth embodiment of the invention provides a method 160 of routing communications traffic carrying signals in a communications network transport node. The steps of the method are shown in FIG. 12.

The method 160 of this embodiment is similar to the method 150 of FIG. 11, with the following modifications. The same reference numbers are retained for corresponding steps.

In this embodiment, the method further comprises, prior to step e., receiving a plurality of electrical traffic signals from the packet switch. Each electrical traffic signal carries respective communications traffic. The electrical traffic signals are selectively combined to form respective further electrical sub-channel signals. The further electrical sub-channel signals are then RF modulated to form corresponding further RF modulated electrical sub-channels. The further RF modulated electrical sub-channels are combined with input RF modulated electrical channel signals to be transmitted, as described above.

In this example, the electrical traffic signals have a first bit rate, such as 10GE or ODU-2/ODU-3, and the method further comprises multiplexing and mapping the traffic signals into a further RF modulated electrical sub-channel signal which has a second, higher, bit rate which is equal to a bit rate of a the output optical signal into which the RF modulated electrical sub-channel signal will be converted.

1. A communications network transport node comprising:
an optical add-drop multiplexer comprising:
a plurality of optical signal processing apparatus each comprising:
an optical input arranged to receive a plurality of input optical channel signals each having a different one of channel wavelengths and each carrying respective communications traffic;
an optical output;
an optical to electrical signal conversion apparatus arranged to receive said input optical channel signals and to convert each said input optical channel signal into a corresponding input radio frequency modulated electrical channel signal; and
an electrical to optical signal conversion apparatus arranged to receive a plurality of output radio frequency modulated electrical channel signals each carrying respective communications traffic and to convert each said output radio frequency modulated electrical channel signal into a corresponding output optical channel signal each having a different one of channel wavelengths and to provide each said output optical channel signal to said optical output;
an electrical signal routing apparatus arranged to receive said input radio frequency modulated electrical channel signals, the electrical signal routing apparatus comprising a plurality of electrical add inputs each arranged to receive a respective further radio frequency modulated electrical channel signal carrying respective communications traffic, and further comprising a plurality of electrical drop outputs, the electrical signal routing apparatus being further arranged to:
determine which of said input radio frequency modulated electrical channel signals are to be dropped and to route each said signal to be dropped to a selected said electrical drop output;
determine which of said input radio frequency modulated electrical channel signals are to be transmitted and to route each said signal to be transmitted to a selected said electrical to optical signal conversion apparatus; and
receive a said further radio frequency modulated electrical channel signal and route said further radio frequency modulated electrical channel signal to a selected said electrical to optical signal conversion apparatus;
and
a packet switch arranged to receive at least one electrical channel signal from at least one said electrical drop output and further arranged to provide at least one further electrical channel signal to be radio frequency modulated and received by a respective said electrical add input.

2. A communications network transport node as claimed in claim 1, wherein said electrical signal routing apparatus is further arranged to split each said input radio frequency modulated electrical channel signal into a plurality of radio frequency modulated electrical sub-channel signals each carrying a respective portion of said communications traffic, each said electrical add input being arranged to receive a respective further radio frequency modulated electrical sub-channel signal, and wherein said electrical signal routing apparatus is further arranged to selectively combine said radio frequency modulated electrical sub-channel signals to be transmitted and said further radio frequency modulated electrical sub-channel signals to form respective output electrical channel signals and to deliver each said output electrical channel signal to a respective said electrical to optical signal conversion apparatus.

3. A communications network transport node as claimed in claim 2, wherein said electrical signal routing apparatus comprises:
a plurality of electrical signal processing apparatus each comprising:
a plurality of electrical signal splitters each arranged to receive a respective said radio frequency modulated input electrical channel signal and to split said radio frequency modulated input electrical channel signal into a plurality of radio frequency modulated electrical sub-channel signals; and
a plurality of electrical signal combiners each arranged to receive a plurality of radio frequency modulated electrical sub-channel signals and further radio frequency modulated electrical sub-channel signals and to combine said signals to form a corresponding said output electrical channel signal;
a plurality of electrical signal drop outputs;
a plurality of electrical signal add inputs; and
an electrical switch apparatus coupled between said electrical signal splitters, said electrical signal combiners of each said electrical signal processing apparatus, said drop outputs and said add inputs, wherein the electrical switch apparatus is arranged to receive from each electrical signal processing apparatus each said radio frequency modulated electrical sub-channel signal to be transmitted and to receive any further radio frequency modulated electrical sub-channel signals from one or more of said add inputs, and wherein the electrical switch apparatus is further arranged to route each said signal to a respective said electrical signal combiner.

4. A communications network transport node as claimed in claim 1, wherein each said optical signal processing apparatus is arranged to receive a wavelength multiplexed input optical signal comprising a plurality of optical channel signals, and wherein each said optical signal processing apparatus further comprises:
an optical signal splitter arranged to receive said wavelength multiplexed input optical signal and to power split said input optical signal into a first part and a second part;
a demultiplexer arranged to receive said first part and to demultiplex said first part into its constituent optical channel signals and to transmit each of said optical channel signals which is to be switched; and
an optical signal combiner arranged to receive said output optical channels signals and the second part of a further input optical signal and to select from said second part each transit optical channel signal, and the optical signal combiner is further arranged to combine said output optical signals and each transit optical channel signal to form a wavelength multiplexed output optical signal and to provide said output optical signal to said optical signal output.

5. A communications network transport node as claimed in claim 1, wherein each said optical signal processing apparatus is arranged to receive a wavelength multiplexed input optical signal comprising a plurality of optical channel signals, and wherein each said optical signal processing apparatus further comprises:
a wavelength selective optical signal splitter arranged to receive said wavelength multiplexed input optical signal and to select a sub-band of said input optical signal comprising a sub-set of said optical channel signals; and
a demultiplexer arranged to receive said sub-band input optical signal and to demultiplex said sub-band input optical signal into its constituent optical channel signals.

6. A communications network transport node as claimed in claim 5, wherein the optical add-drop multiplexer further comprises:
a multiplexer; and
a demultiplexer arranged to receive a wavelength multiplexed input optical signal comprising a plurality of optical channel signals, to demultiplex said input optical signal into a plurality of sub-band input optical signals each comprising a different sub-set of said plurality of optical channel signals, and to route a respective said sub-band input optical signal to each said optical signal processing apparatus and to route at least one other said sub-band input optical signal to said multiplexer.

7. A communications network transport node as claimed in claim 1, wherein the node further comprises an electrical signal combiner and an electrical signal modulation apparatus, the electrical signal combiner being arranged to receive from said packet switch a plurality of electrical traffic signals each carrying respective communications traffic and to combine said electrical traffic signals to form a said further electrical sub-channel signal and the electrical signal modulation apparatus is arranged to radio frequency modulate each said further electrical sub-channel signal to form a corresponding radio frequency modulated electrical sub-channel signal to be received by a respective add input.

8. A communications network transport node as claimed in claim 7, wherein said communications traffic has a first bit rate and said electrical signal combiner comprises transmission apparatus arranged to multiplex and map said traffic into a said further electrical sub-channel signal having a second, higher bit rate equal to a bit rate of a said output optical signal.

9. An optical add-drop multiplexer comprising:
a plurality of optical signal processing apparatus each comprising:
an optical input arranged to receive a plurality of input optical channel signals each having a different one of channel wavelengths and each carrying respective communications traffic;
an optical output;
an optical to electrical signal conversion apparatus arranged to receive said input optical channel signals and to convert each said input optical channel signal into a corresponding input radio frequency modulated electrical channel signal; and
an electrical to optical signal conversion apparatus arranged to receive a plurality of output radio frequency modulated electrical channel signals each carrying respective communications traffic and to convert each said output radio frequency modulated electrical channel signal into a corresponding output optical channel signal each having a different one of said plurality of channel wavelengths and to provide each said output optical channel signal to said optical output;
and
an electrical signal routing apparatus arranged to receive said input radio frequency modulated electrical channel signals, the electrical signal routing apparatus comprising a plurality of electrical add inputs each arranged to receive a respective further radio frequency modulated electrical channel signal carrying respective communications traffic, and further comprising a plurality of electrical drop outputs, the electrical signal routing apparatus being further arranged to:
determine which of said input radio frequency modulated electrical channel signals are to be dropped and to route each said signal to be dropped to a selected said electrical drop output;
determine which of said input radio frequency modulated electrical channel signals are to be transmitted and to route each said signal to be transmitted to a selected said electrical to optical signal conversion apparatus; and
receive a said further radio frequency modulated electrical channel signal and route said further radio frequency modulated electrical channel signal to a selected said electrical to optical signal conversion apparatus.

10. A method of routing communications traffic carrying signals in a communications network transport node, the method comprising:
a. receiving a plurality of input optical channel signals each carrying respective communications traffic;
b. converting each said input optical channel signal into a corresponding input radio frequency modulated electrical channel signal;
c. determining which of said input radio frequency modulated electrical channel signals are to be dropped and routing each said signal to be dropped to an electrical signal drop output for delivery to a packet switch;
d. determining which of said input radio frequency modulated electrical channel signals are to be transmitted and converting each said signal to be transmitted into an output optical channel signal;
e. receiving a plurality of further radio frequency modulated electrical channel signals each carrying respective communications traffic and converting each said signal into an output optical channel signal; and
f. delivering each said output optical channel signal to a respective optical output.

11. A method as claimed in claim 11, wherein step b. further comprises splitting each said input radio frequency modulated electrical channel signal into a plurality of input radio frequency modulated electrical sub-channel signals, step c. comprises determining which of said input radio frequency modulated electrical sub-channel signals are to be dropped and routing each said sub-channel signal to be dropped to the electrical signal drop output, and step e. comprises selectively combining sub-sets of said plurality of said input radio frequency modulated electrical sub-channel signals and said further radio frequency modulated electrical sub-channel signals to form respective said output electrical channel signals and converting each said output electrical channel signal into a corresponding output optical channel signal.

12. A method as claimed in claim 11, wherein the method further comprises:
prior to step a., receiving a wavelength multiplexed input optical signal comprising a plurality of optical channel signals and splitting said input optical signal into a first part and a second part;
demultiplexing said first part into its constituent optical channel signals and selecting each of said optical channel signals which is to be switched;
selecting from said second part each transit optical channel signal; and
combining said output optical channel signals and each transit optical channel signal to form a wavelength multiplexed output optical signal and providing said output optical signal to said optical signal output.

13. A method as claimed in claim 11, wherein the method further comprises prior to step e.:
receiving from said packet switch a plurality of electrical traffic signals each carrying respective communications traffic and combining said electrical traffic signals to form a said further electrical sub-channel signal; and
applying radio frequency modulation to each said further electrical sub-channel signal to form a corresponding radio frequency modulated electrical sub-channel signal to be received by a respective add input.

14. A method as claimed in claim 13, wherein said electrical traffic signals have a first bit rate and the method further comprises multiplexing and mapping said traffic into a said further electrical sub-channel signal having a second, higher bit rate equal to a bit rate of a said output optical signal.

15. An optical add-drop multiplexer as claimed in claim 9, wherein said electrical signal routing apparatus is further arranged to split each said input radio frequency modulated electrical channel signal into a plurality of radio frequency modulated electrical sub-channel signals each carrying a respective portion of said communications traffic, each said electrical add input being arranged to receive a respective further radio frequency modulated electrical sub-channel signal, and wherein said electrical signal routing apparatus is further arranged to selectively combine said radio frequency modulated electrical sub-channel signals to be transmitted and said further radio frequency modulated electrical sub-channel signals to form respective output electrical channel signals and to deliver each said output electrical channel signal to a respective said electrical to optical signal conversion apparatus.

16. An optical add-drop multiplexer as claimed in claim 9, wherein said electrical signal routing apparatus comprises:
a plurality of electrical signal processing apparatus each comprising:
a plurality of electrical signal splitters each arranged to receive a respective said radio frequency modulated input electrical channel signal and to split said radio frequency modulated input electrical channel signal into a plurality of radio frequency modulated electrical sub-channel signals; and
a plurality of electrical signal combiners each arranged to receive a plurality of radio frequency modulated electrical sub-channel signals and further radio frequency modulated electrical sub-channel signals and to combine said signals to form a corresponding said output electrical channel signal;
a plurality of electrical signal drop outputs;
a plurality of electrical signal add inputs; and
an electrical switch apparatus coupled between said electrical signal splitters, said electrical signal combiners of each said electrical signal processing apparatus, said drop outputs and said add inputs, wherein the electrical switch apparatus is arranged to receive from each electrical signal processing apparatus each said radio frequency modulated electrical sub-channel signal to be transmitted and to receive any further radio frequency modulated electrical sub-channel signals from one or more of said add inputs, and wherein the electrical switch apparatus is further arranged to route each said signal to a respective said electrical signal combiner.

17. An optical add-drop multiplexer as claimed in claim 9, wherein each said optical signal processing apparatus is arranged to receive a wavelength multiplexed input optical signal comprising a plurality of optical channel signals, and wherein each said optical signal processing apparatus further comprises:
an optical signal splitter arranged to receive said wavelength multiplexed input optical signal and to power split said input optical signal into a first part and a second part;
a demultiplexer arranged to receive said first part and to demultiplex said first part into its constituent optical channel signals and to transmit each of said optical channel signals which is to be switched; and
an optical signal combiner arranged to receive said output optical channels signals and the second part of a further input optical signal and to select from said second part each transit optical channel signal, and the optical signal combiner is further arranged to combine said output optical signals and each transit optical channel signal to form a wavelength multiplexed output optical signal and to provide said output optical signal to said optical signal output.

18. An optical add-drop multiplexer as claimed in claim 9, wherein each said optical signal processing apparatus is arranged to receive a wavelength multiplexed input optical signal comprising a plurality of optical channel signals, and wherein each said optical signal processing apparatus further comprises:
a wavelength selective optical signal splitter arranged to receive said wavelength multiplexed input optical signal and to select a sub-band of said input optical signal comprising a sub-set of said optical channel signals; and
a demultiplexer arranged to receive said sub-band input optical signal and to demultiplex said sub-band input optical signal into its constituent optical channel signals.

19. An optical add-drop multiplexer as claimed in claim 18, wherein the optical add-drop multiplexer further comprises:
a multiplexer; and
a demultiplexer arranged to receive a wavelength multiplexed input optical signal comprising a plurality of optical channel signals, to demultiplex said input optical signal into a plurality of sub-band input optical signals each comprising a different sub-set of said plurality of optical channel signals, and to route a respective said sub-band input optical signal to each said optical signal processing apparatus and to route at least one other said sub-band input optical signal to said multiplexer.

20. An optical add-drop multiplexer as claimed in claim 9, wherein the node further comprises an electrical signal combiner and an electrical signal modulation apparatus, the electrical signal combiner being arranged to receive from said packet switch a plurality of electrical traffic signals each carrying respective communications traffic and to combine said electrical traffic signals to form a said further electrical sub-channel signal and the electrical signal modulation apparatus is arranged to radio frequency modulate each said further electrical sub-channel signal to form a corresponding radio frequency modulated electrical sub-channel signal to be received by a respective add input.
